(19) United States
(12) Patent Application Publication
(10) Pub. No.: US 2020/0319288 A1
(43) Pub. Date: Oct. 8, 2020

(54) DUAL ACOUSTIC PRESSURE AND HYDROPHONE SENSOR ARRAY SYSTEM

(71) Applicant: Fiber Optic Sensor Systems Technology Corporation, Washington, DC (US)

(72) Inventors: Christopher Vizas, Washington, DC (US); Nicholas Lagakos, Silver Spring, MD (US); Patrick Hernandez, Silver Spring, MD (US)

(73) Assignee: Fiber Optic Sensor Systems Technology Corporation, Washington, DC (US)

(21) Appl. No.: 16/906,756

(22) Filed: Jun. 19, 2020

Related U.S. Application Data
(63) Continuation of application No. 15/365,382, filed on Nov. 30, 2016.

(51) Int. Cl. G01S 3/80; G01H 9/00; G01L 15/00; G01L 23/16; G01S 3/801; G01S 3/808

(52) U.S. Cl. CPC G01S 3/8006; G01H 9/006; G01S 3/8083; G01L 23/16; G01S 3/801; G01L 15/00

(57) ABSTRACT

An aspect of the invention is directed to a system of both atmospheric and underwater sensors for measuring pressure waves from a noise source. A system of pressure sensors can be formed to determine the location of an external noise source, whether in air or underwater. The system includes at least two arrays consisting of pressure sensors, including at least one atmospheric pressure sensor and at least one underwater pressure sensor, such as a hydrophone. Each sensor may be a seven-fiber intensity modulated fiber optic pressure sensor. The system includes an analog to digital converter for digitizing the pressure data received from each sensor and a processor which processes the received signals to calculate an approximate location of the noise source based upon the pressure signals received by the sensors at different times of arrival. The system can provide this capability in remote applications due to its low power requirements.

### CROSS REFERENCE TO RELATED APPLICATIONS

The present application is a continuation of U.S. application Ser. No. 15/365,382, filed Nov. 30, 2016, the disclosure of which is hereby incorporated by reference.

### FIELD OF INVENTION

This invention relates to a pressure sensor array system, and more specifically to an array of intensity modulated fiber optic pressure sensors for dynamically measuring pressure in both above-water and underwater environments.

### BACKGROUND

This invention relates to a sensor array for detection of both above-water and underwater pressure waves using a common sensor system. Because the mechanical properties of water differ from that of air, pressure waves propagate with different properties in each environment, such that simultaneous measurement of atmospheric and underwater pressure provides information that may be useful to determine the point of origin of a pressure wave of interest and characterize the source. Using a combination of signals derived from above-water and below-water pressure sensors, it is possible to readily locate the emanating source of a pressure wave from the signals received (i.e.—locate in air or underwater), detect signals earlier due to the differing propagation characteristics of the mediums, obtain information regarding above-water and below-water pressure waves emanating from a common source, and use this information to improve the locational and signature identification capability of the system. The system also possesses the unique aspect of being able to provide this detection ability in remote locations due to its low total power requirement and offers the ability to detect very low frequency signals.

Sensor arrays are limited by the performance characteristics of their component sensors, which may render impractical the deployment of an array in certain applications. Remote sensing applications, such as in a marine environment, is an example of one application where the limitations of the component sensors, such as power requirements, makes array deployment impractical using standard technological approaches. However, due to the proliferation of airborne and seaborne vehicles which may pose a security threat, it has become increasingly desirable to detect the presence of these vehicles even in remote settings. It is therefore desirable to have a sensor array system capable of deployment in remote applications, and with the capability to provide information that, when combined with measurements in multiple media (i.e.—above and below water), provides richer data from which to derive an understanding of the nature of the radiating source.

Acoustic (or above-water) pressure waves can be detected using a microphone, which measures atmospheric pressure waves (whether audible or beyond the range of human hearing) in a particular area of interest. Commercially available electrical microphones, for example, detect pressure applied on their diaphragm by monitoring small changes in the capacitance measured between the diaphragm and a charged backplate placed closely to the diaphragm. Among the sensors available to meet this need are standard capacitor microphones and electret microphones. Standard capacitor microphones have good performance in lab applications, but require a substantial external power source and have a high total power requirement. Electret microphones are pre-charged, so they use less power, but this charge depletes over time, which can affect performance and requires frequent recalibration. These devices also are limited at measurement of low frequency signals. These devices are also sensitive to EMI, which can be a limiting factor in certain situations.

An alternative approach is to use intensity modulated fiber optic pressure sensors, which have high levels of sensitivity, the ability to detect very low frequency signals, a low total power requirement, insensitivity to EMI, and are simpler and less expensive than similar solutions. Various types of intensity modulated fiber optic pressure sensors are disclosed in U.S. Pat. Nos. 7,379,630, 7,149,374, 7,020,354, 7,460,740, and 7,697,798 to Lagakos, et al. (the “Pressure Sensor Patents”), the disclosures of which are incorporated herein by reference in their entireties.

For underwater applications, hydrophones or similar devices measure sound or the existence of pressure waves in a particular area of interest in underwater environments. Most commercially available hydrophones typically use a piezoelectric crystal as the sensing element. When pressure is applied on the PZT, a small surface electrical charge is generated, resulting in a small electrical voltage, which is typically amplified at the sensor. The electrical signal and the electronic amplifier make the device sensitive to electromagnetic interference. In addition, such PZT sensors are generally not very sensitive at low frequencies (i.e.—below about 1 Hz). Like the microphones discussed above, the power requirements of these sensors and associated electronics equipment, results in a high total power requirement, which is problematic in remote applications.

An alternative approach to underwater pressure sensing utilizing an intensity modulated fiber optic sensor is disclosed by Lagakos et al. in U.S. Pat. No. 8,094,519, the disclosure of which is incorporated herein by reference in its entirety (the “Hydrophone Patent”) (the Pressure Sensor Patents and the Hydrophone Patent being collectively referred to herein as the “U.S. Government Patents”). Like the intensity modulated fiber optic pressure sensors discussed above, these sensors also have high levels of sensitivity, the ability to detect very low frequency signals, a low total power requirement, insensitivity to EMI, and are simpler and less expensive than similar solutions.

By deploying pressure sensors at different locations, it is possible to differentiate between different acoustic sources and to approximate the location of a noise source. Using multiple sensors also allows for the deployment of sensors that are sensitive to different frequency ranges. Microphones and microphone arrays are often used to measure sound pressure levels, for various reasons, for example, to isolate the mechanical source of a troublesome noise or to locate the position of a noise source. To determine a sound intensity vector, current devices typically include one, two, or three pairs of microphones. A spherical microphone array for detecting, tracking, and reconstructing signals to determine vector acoustic intensity fields using a spherical array of atmospheric pressure sensors is disclosed in U.S. Pat. No. 7,599,248 to Williams. An underwater pressure sensor array is disclosed in U.S. Pat. No. 6,172,940 to McConnell.

However, for the reasons set forth above these arrays are limited to a single atmospheric application (i.e.—air or underwater, but not both). These arrays are also limited by their sensor inputs. For remote applications, in particular, the power requirements of an array (either atmospheric or submarine) impose a practical limit on the ability to use a given sensor type (such as a capacitor microphone) or the number of sensors to be used. These problems are compounded as additional sensors are added, which may be desirable to obtain information regarding a range of frequency signals or signals from other types of sensors.

Given the different properties in the propagation of pressure waves in atmospheric versus underwater environments, useful information regarding the pressure wave's originating source and location can be determined with greater accuracy and speed by using an array that combines the strengths of both atmospheric and underwater pressure sensor arrays. This may be useful, for example, to detect low frequency pressure waves that emanate from equipment contributing different noises (pressure waves) at different frequencies to enable detection of remote objects of interest that may be aerial, submarine, or a combination of the two. However, this requires a system capable of acquiring the data from multiple sensor sources and correlating the pressure wave data from the sensors to account for the pressure wave propagation through multiple media with differing propagation characteristics.

What is needed is an array system capable of gathering information from sensors in multiple media that uses multiple sensor types that share a common sensing approach and is capable of accommodating a multitude of sensors to achieve a high level of performance, but uses only limited power. Therefore, a dual array utilizing intensity modulated fiber optic sensors provides an alternative to existing sensor array approaches.

Therefore, it is an object of this invention to provide a pressure sensor system featuring an array of both atmospheric pressure sensors and underwater pressure sensors, featuring low total power usage, and capable of the measurement and correlation of pressure waves in both above-water and below-water environments in order to determine the location of a noise source of interest.

### SUMMARY

An aspect of the invention is directed to a system of atmospheric and underwater sensors for measuring pressure emanating from a noise source. A system of such pressure sensors can be formed to determine the location of a noise source external to the system, whether that noise source is located in the air or underwater. The system may include at least two arrays consisting of a plurality of pressure sensors, including at least one atmospheric pressure sensor (located in the air) and at least one underwater pressure sensor, such as a hydrophone (located underwater). The sensors may be seven-fiber intensity modulated fiber optic pressure sensors disclosed in the U.S. Government Patents. The system may include an analog to digital converter for digitizing pressure data received from each sensor, and a processor for determining acoustic intensity at each location, the processor having a means to process the signals received from each sensor to calculate an approximate location of the noise source based upon the pressure signals received by the system's various sensors at different times of arrival. The system possesses the unique aspect of being able to provide this detection ability in remote locations due to its relatively low total power requirement.

The system's analog to digital converter may receive analog electrical signals from the plurality of pressure sensors that correspond to pressure measurements and convert the signals into digital signals representing pressure data from each microphone in the array. The signals may then be processed to account for time of arrival, propagation characteristics of the medium, and geometry of the various sensors to obtain information regarding the noise source. The digital signals may be transferred to a processor which receives the digital signals and determines the acoustic vector intensity at many different locations exterior to the array. The acoustic vector intensity may be calculated at the different locations and provides an output that is representative of the acoustic vector intensity acquired from of each of the sensor outputs, which provides an indication as to the radiating source of the pressure wave.

Thus, the system may transform the sensor signals into data representing the magnitude and direction of the pressure wave intensity at different locations within a volume outside the array. The data can be output as a visual display, including as graphical representations whose size, colors, position, or direction indicate the acoustic intensity and direction of the noise source the sensors used to determine the directionality and source of the pressure wave. The data can also be stored for further examination and processing or communicated to another device. The signal may also be matched to a library of acoustic signatures to classify the noise source.

### BRIEF DESCRIPTION OF THE DRAWINGS

FIG. 1 shows an exemplary embodiment of a fiber optic sensor system for measuring pressure waves emanating from an atmospheric radiation source.

FIG. 2 shows an exemplary embodiment of a fiber optic sensor system for measuring pressure waves emanating from a source with both atmospheric and underwater components.

FIG. 3 shows an exemplary embodiment of a fiber optic sensor system for measuring pressure waves emanating from an underwater radiation source.

### DETAILED DESCRIPTION OF THE INVENTION

An aspect of the invention is directed towards a system of pressure sensors for simultaneous measurement of atmospheric and underwater pressure.

The sensors used in the system described herein may use intensity modulated fiber optic sensor technology to measure pressure emanating from a noise source. While the sensors used in the system incorporate several pressure sensor embodiments designed to isolate for measurement of pressure in various environments (atmospheric and underwater), the fiber optic sensors that are used in the system share certain common characteristics that are disclosed in the U.S. Government Patents.

The sensors each may include an optical fiber bundle having a transmitting fiber and at least one receiving fiber. This fiber probe is then placed adjacent to a reflective surface that is part of or attached to a material. A housing may be included, and may be affixed to the optical fiber bundle at a first end and to the reflector body at a second end. The sensor can have one transmitting fiber and one receiving fiber, or can have one transmitting fiber and a plurality of receiving fibers. The reflective surface may be spaced apart from the ends of the fibers and positioned so that light, transmitted through the transmitting fiber, is reflected by the reflective surface into at least one receiving fiber. A light sensing element may be coupled to the second end of the at least one receiving fiber, so that in operation light from a light source, launched into the transmitting fiber, propagates through the fiber and emerges at the end, propagates a short distance from the end of the fiber, and is reflected at least partially by the reflector body back into the receiving fibers. The reflected light then returns through the receiving fibers, and is detected by a light sensing element.

In operation, the introduction of a pressure wave to the sensor causes a displacement in the material, which may be a flexible membrane, which causes a change in the distance between the fiber end and the reflective surface, modulating the amount of light received in the receiving fiber. The change in distance between the fiber ends and the reflective surface modulates the amount of light received by the light sensing element. The intensity of the light received is therefore modulated in relation to the physical effect of interest. Each sensor may be constructed so as to isolate for the physical phenomena to be measured (here, pressure) but other fiber optic sensors may be used in the system to measure other electromagnetic phenomena (voltage, current, electric field, magnetic field), pressure, acceleration, strain, temperature, displacement, or other physical phenomena. In each sensor application, the phenomenon to be measured is indicated by the displacement of the material in response to the phenomenon, and the displacement of the material is measured by the amount of light detected by the light detecting element. One-fiber, two-fiber, and seven-fiber fiber optic sensors with pressure-deflected diaphragms provide high levels of performance and can be used to measure pressure in a range of environments, and readily adapted based on a required sensitivity, bandwidth, and the expected static pressure for a desired application.

A system of such pressure sensors can be formed to determine acoustical intensity external to the system. The system may include an array consisting of a plurality of pressure sensors, including at least one atmospheric pressure sensor (located in the air) and at least one underwater pressure sensor, such as a hydrophone (located underwater), an analog to digital converter for digitizing pressure data from each microphone, and a processor for determining acoustic intensity at each location, the processor having a means to process the signals received from each sensor to determine the pressure and velocity of the originating waves and account for the signal arrival at the system's various sensors at different times.

The two or more pressure sensors of the array may be set in a fixed position relative to each other with adjacent sensors separated by a known geometry, such as by arranging the sensors in a predetermined configuration. A pressure wave originating from a source external to the array will propagate through the conductive mediums (air and water) and arrive at the various pressure sensors at different times. By deploying the sensors at different locations, it is possible to differentiate between different acoustic sources. Differences in the time of arrival at the various sensors of the array can be used to derive information regarding the location of the originating source of the pressure wave. It is also suitable to deploy a number of sensors that are sensitive to different frequency ranges. Processing of the sensor data allows for correlation of a common wave regardless of the medium, provided that the medium is known.

The velocity of sound in a gas can be found as follows:

$${C}_{G} = \sqrt{\frac{p * κ}{ρ}} \qquad ( Equation 1 )$$

Where C_{G}=the velocity of sound of the gas in m/s, p=the pressure of the gas in Pa, κ=the adiabatic coefficient of the gas (unitless) and p=the density of the gas in kg/m³. For example, it is known that sound moves at approximately 340 m/s in dry air at 20° C. The pressure of the gas has several dependencies of which will determine its value at a given temperature, humidity, and altitude.

Similarly, the velocity of sound in a liquid can be found as follows:

$${C}_{Fl} = \sqrt{\frac{K}{ρ}} \qquad ( Equation 2 )$$

Where C_{Fl}=the velocity of sound of the liquid in m/s, K=the compression modulus of the liquid in N/m² and ρ=the density of the liquid in kg/m³. For example, the speed of sound in water is approximately 1480 m/s at 20° C. Similar to air, the speed of sound in a liquid such as water is affected by interdependent variables such as the temperature, salinity, and pressure of the water that the pressure wave is propagating through. For example, Chen and Millero have derived the following empirical formula for approximating the speed of sound in seawater under various levels of salinity, temperature, and pressure:

U(S,t,p)=C_w(t,p)+A(t,p)S+A(t,p)S\hat{ }(3/2)+A(t,p)S\hat{ }2 (Equation 3)

Where U=the speed of sound in seawater in m/s, S=the salinity of the seawater in parts per thousand, t=the temperature of the water in degrees Celsius, and p=the pressure of the water in decibars. See Chen and Millero (1977).

It is well known that when a pressure wave meets a point of interface between two mediums, such as air and water, the wave will refract, resulting in a change of the direction of wave propagation according to Snell's law. Refraction of a pressure wave at the transition between two mediums is defined under Snell's law by the following formula:

$$\frac{sin ɛ}{sin {ɛ}^{′}} = \frac{{c}_{1}}{{c}_{2}} \qquad ( Equation 3 )$$

Where ε=the incidence angle, \acute{ε}=the refraction angle and c1 and c2=the wave velocities in medium 1 and medium 2 respectively. Further, the law of reflection states that the angle of incidence equals the angle of reflection (i.e., ε=\acute{ε}). Thus, given the known propagation speed of a pressure wave in two mediums, the angle of refraction at the point of transition between the two mediums can be ascertained.

Various mediums also have differing acoustic impedances. The characteristic acoustic impedance of the medium with respect to the propagation of the wave in the medium is defined by the following formula:

Z=ρ*c (Equation 4)

Where Z=the characteristic acoustic impedance, p=the density of the medium and c=the velocity of sound in the medium. When a pressure wave contacts a new medium with different characteristic acoustic impedances, some of the energy is reflected from the transition surface and some of the energy is transferred to the new medium. This is defined as a relationship between the degree of sound reflection and degree of sound absorption between the two mediums.

The laws of energy conservation holds for this impedance relationship with ρ+α=1 where ρ=the degree of pressure reflection and α=the degree of pressure transfer to the second medium. Both of these terms are formulated from the characteristic acoustic impedances as follows:

$$ρ = {( \frac{{Z}_{2} - {Z}_{1}}{{Z}_{2} + {Z}_{1}} )}^{2} , α = 1 - {( \frac{{Z}_{2} - {Z}_{1}}{{Z}_{2} + {Z}_{1}} )}^{2} \qquad ( Equation 5 )$$

For example, when Z₁=Z₂, the there is no reflected portion of the wave and all energy is transferred to the new medium.

From the above, it can be seen that some portion of the pressure wave will be transferred into the second medium and propagate at a different speed and at a different angle of orientation than the original pressure wave, but that these characteristics can be known.

As this discussion illustrates, with the careful measurement and calculation of basic properties of the mediums, a prediction as to the direction and intensity of a pressure wave can be made across mediums. With the inclusion of multiple measurement sources as in an array structure, a very accurate determination of direction can be determined through the application of various signal processing means. It will be appreciated from the above discussion that the combination of above-water and below-water pressure sensors allow for the detection of a pressure wave, the calculation of its distance from the source, and the angle from which the pressure wave emanated. Since the angles of orientation of the various pressure sensors are known, and the relative intensity of a pressure wave at any given sensor of the array can be readily determined, a relative phase angle of the pressure wave can also be determined.

Using the sensor inputs from the dual array, the directionality and source of the pressure wave using the system can be found as follows. The analog to digital converter receives analog electrical signals from the plurality of pressure sensors and converts the signals into digital signals representing pressure data from each microphone in the array. A delay function may be used to differentiate between the relative times of arrival of a given wave, for example, a wave with a given frequency arriving at a particular sensor prior to arriving at a second sensor due to the difference in the propagation characteristics of the medium and the known geometries between the sensors of the array system. The signals can then be correlated to use the phase information present in signals picked up by sensors that are spatially separated, allowing for a determination of the direction of arrival of the wave.

The digital signals are transferred to a processor which receives the digital signals and determines the acoustic vector intensity at many different locations exterior to the array. The acoustic vector intensity is calculated at the different locations and provides an output that is representative of the acoustic vector intensity acquired from of each of the sensor outputs, which collectively provide an indication as to the radiating source of the pressure wave.

There are many available means to process the signals associated with the dual array system in such a manner. For example, in U.S. Pat. No. 7,599,249 to Williams, a system and method for determining vector acoustic intensity fields using a spherical array of acoustic sensors, and a regularization technique is disclosed. This system includes a spherical array of a number of microphones that image the acoustic intensity vector throughout a large volume internal and external to the spherical array. That system includes a spherical array of a plurality of microphones, an analog to digital converter for digitizing pressure data from each microphone, and a processor for determining the acoustic intensity at each location, the processor having computer software adapted to apply a regularization filter to spherical wave equations for pressure and velocity. The system disclosed herein may utilize a similar approach, but the use of any particular signal processing technique is not required.

Using signal processing techniques, the described embodiment of the system herein transforms the sensor signals into data representing the magnitude and direction of the pressure wave intensity at different locations within a volume outside the array. The data can be output as a visual display, including as graphical vectors whose size, colors, position, and direction indicate the acoustic intensity and direction of the noise source the sensors used to determine the directionality and source of the pressure wave. The data can also be stored for further examination and processing or communicated to another device. The signal may also be matched to a library of acoustic signatures to classify the noise source.

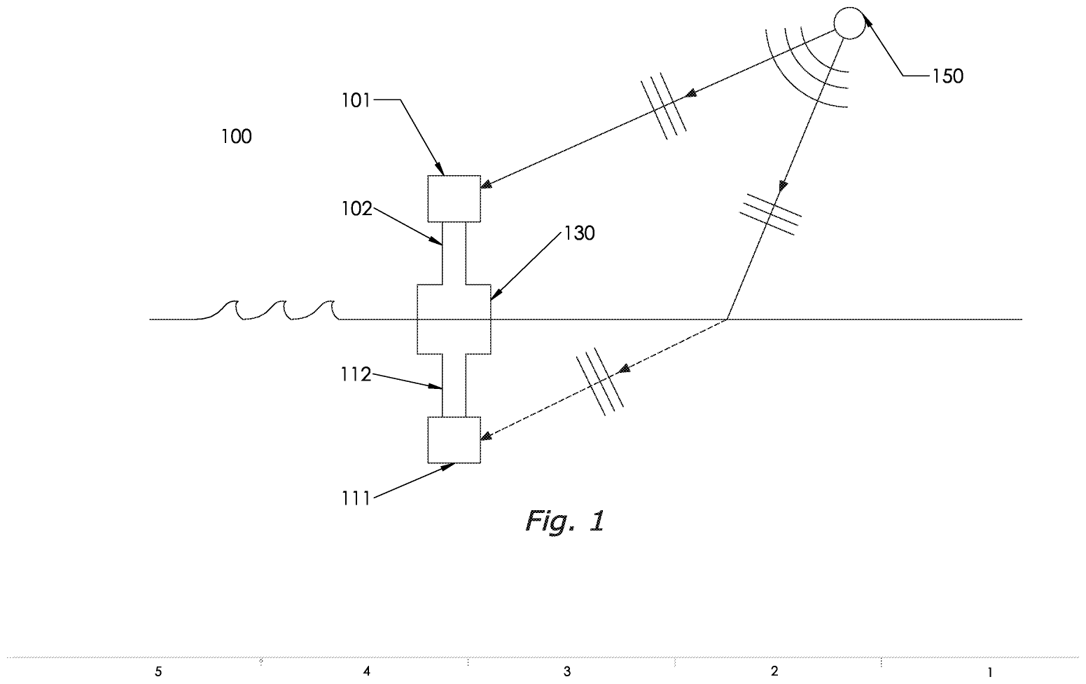

FIG. 1 illustrates an exemplary embodiment of the dual array according to an embodiment of the invention. The array 100 includes a number of acoustic pressure sensors 101 held in position by a rigid frame 102. In this example, 56 fiber optic pressure sensor microphones are arranged using a frame of a spherical shape with a set radius between each microphone, providing for consistent separation of each sensor. The system also includes a number of hydrophones 111 also held in position by a rigid frame 112 and with a given separation between each hydrophone. In this example, the hydrophone portion of the array is a vertical array. The supporting frames of the two arrays 102 and 112 are mounted to a common supporting structure, such a stationary floating buoy 130. However, the array may be positioned in any manner so as to be at least temporarily set in a stationary position to allow for signal detection. This allows for the array system to be mobile in nature and easily repositioned, if desired.

The array can be larger or smaller in size, and can have more or fewer sensors, different kinds of sensors (such as piezoelectric microphone or other MEMS pressure sensors in alternative to fiber optic sensors), as determined by the cost of the sensors, the cost of the associated electronics per channel, the desired size of the array, the frequencies to be detected, and the desired resolution and accuracy of the array output. In order to achieve optimal performance, the sensors used should be as close to identical as possible in their response. Thus, it is preferable that the sensors share a common sensing approach. Here, intensity modulated fiber optic sensors are used for both the above-water and below-water sensor arrays.

As shown in FIG. 1, the pressure radiator (noise source) 150 is aerial in nature (such as an airplane or a helicopter). The radiation of pressure waves from the noise source will propagate through the air at a given speed, as discussed in Equation 1. A portion of the pressure wave will reach the interface point between the air and water. At this point, a portion will be reflected, and a portion will be transferred into the second medium and propagate at a different speed (as described in Equation 2) and at a different angle of orientation than the original pressure wave (according to Snell's law).

Each of the acoustic sensors 101 and hydrophones 111 receive the pressure waves from the radiating source and each produce an electrical signal with a voltage corresponding to the pressure sensed at that location. For fiber optic pressure sensors, the electric signal is produced by a light detecting means which receives light from each of the sensors that is indicative of the pressure sensed. The use of intensity modulated fiber optic sensors allows for these electronics to be shared, as both sensor types utilize light from LEDs to drive the sensors (which can also be shared), and use a common light detector to generate the analog signal representative of the pressure wave detected. This has the added advantage of generating a common measurement input signal that can be readily correlated across sensor types and does not require further conversion, reducing processing needs. The analog signals are then sent to an analog to digital converter (not shown) which receives the analog signals from each array sensor (each a single channel) and converts the received signals into digital signals for each channel.

The digital signals are transferred to a processor (not shown) which receives the digital signals at different times depending upon the pressure conductive medium and applies a filter to account for the delay and correlates the signal in order to determine the acoustic vector intensity at each of the sensors at a common point in time. This output permits rapid calculation of the location of greatest acoustic vector intensity, which indicative of the source of the noise.

The analog to digital conversion and processing can be performed locally, such as at the buoy, and then the output transmitted through an alternative communications means (transmitted via satellite, cellular, or fiber optic cable, etc.), or these functions can be processed remotely. The signals can be processed and communicated in real time or can be stored for future analysis.

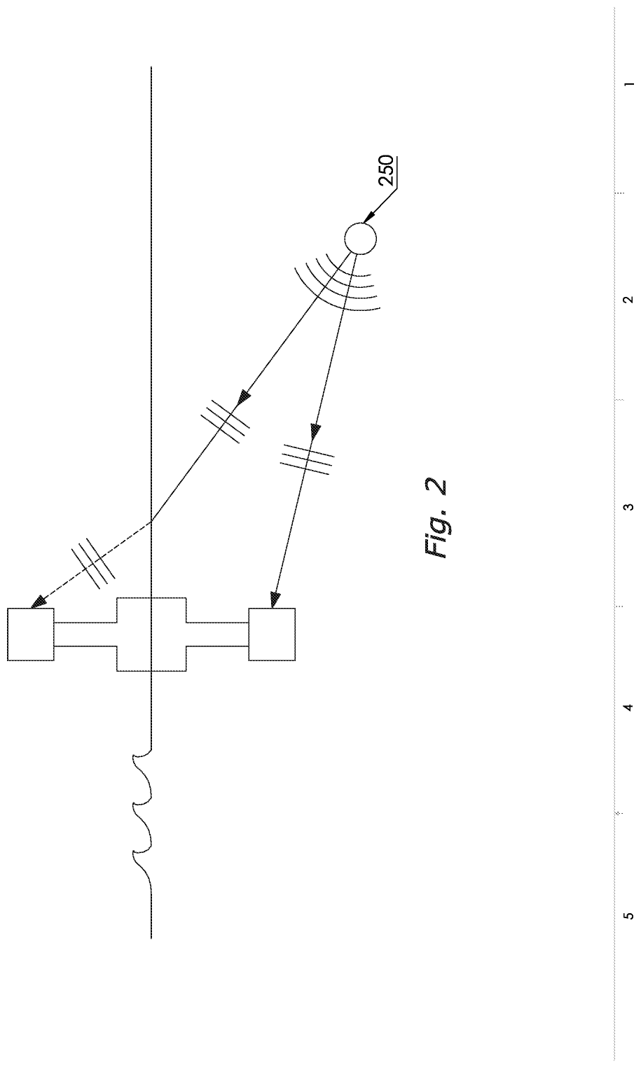

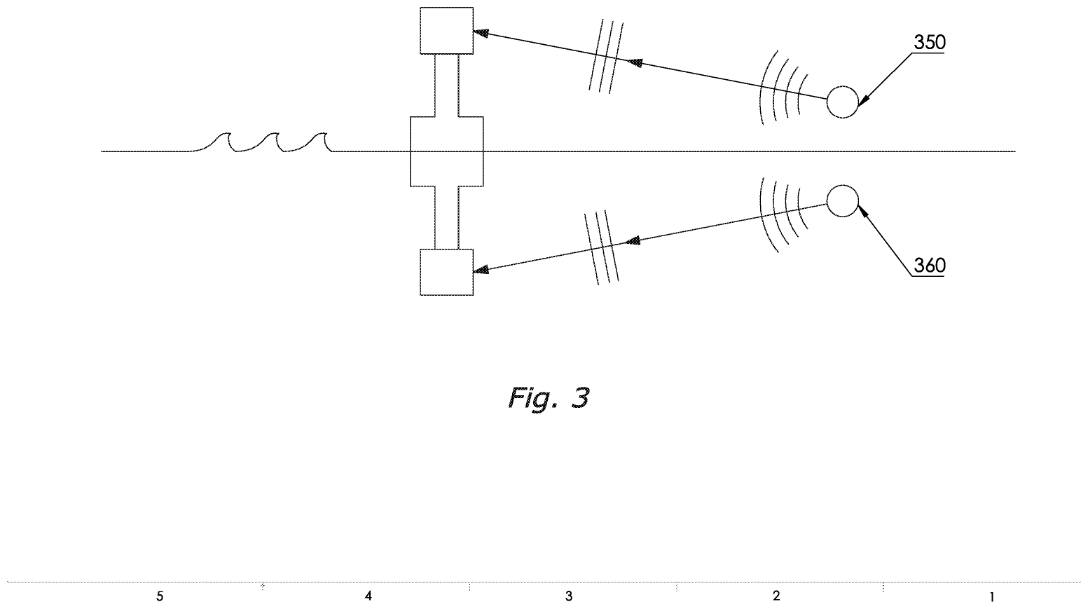

FIG. 2 illustrates an instance in which the pressure radiator (noise source) 250 is underwater (such as a submarine or the propeller of a marine vessel). The performance of the array system is the same, but with the difference that very little of the pressure wave will be transmitted from the water into the air for detection. This would result in a strong pressure signal received for the underwater portion of the array, with little to no pressure signal received by the acoustic portion of the array, being indicative of an underwater noise source. This is in contrast to the signal received in FIG. 1, wherein a strong acoustic signal would be accompanied by a relatively weaker (but detectable) signal from the hydrophone portion of the array, being indicative of an aerial noise source. FIG. 3 illustrates an instance in which the pressure radiator (noise source) has both above-water 350 and underwater 360 components (such as from the engine and the propeller of a marine vessel).

Thus, it can be seen that the use of a dual pressure sensor array system can provide valuable information regarding a particular noise source regardless of whether the noise source is located in the air or underwater. The array can be modified depending on the desired performance, size, cost, and power requirements for a given application. The array can be stationary, such as attached to a marine buoy, or can be mounted to a platform in order to be easily deployable. Although this invention has been described in relation to the exemplary embodiments, it is well understood by those skilled in the art that other variations and modifications can be effected on the preferred embodiments without departing from the scope and spirit of the invention as set forth herein.

The invention claimed is:

1. A fiber optic sensor system for measuring pressure waves, comprising:
at least one fiber optic pressure sensor arranged to detect underwater pressure waves;
at least one fiber optic pressure sensor arranged to detect atmospheric pressure waves;
at least one processor, such that when a pressure wave emanates from a source, the underwater pressure sensor(s) and the atmospheric pressure sensor(s) detect the pressure wave and transmit the pressure data to the processor for evaluating the pressure wave source.

2. The system of claim 1, wherein each of the pressure sensors is a seven-fiber intensity modulated fiber optic pressure sensor.

3. The system of claim 1, further comprising at least one analog to digital converter arranged to convert the output data from the pressure sensors to a digital format.

4. The system of claim 1, wherein the at least one fiber optic pressure sensor arranged to detect underwater pressure waves comprises more than one fiber optic pressure sensor arranged in an array with the sensors set in a fixed position relative to each other with adjacent sensors separated by a known geometry.

5. The system of claim 1, wherein the at least one fiber optic pressure sensor arranged to detect atmospheric pressure waves comprises more than one fiber optic pressure sensor arranged in an array with the sensors set in a fixed position relative to each other with adjacent sensors separated by a known geometry.

6. The system of claim 1, further comprising a visual display.

7. The system of claim 1, further comprising a means for storing the pressure data detected by the pressure sensors.

8. The system of claim 1, further comprising data storage for storing a library of signatures for comparison to the detected pressure waves.

9. The system of claim 1, further comprising at least one additional fiber optic sensor for detecting other characteristics of the media in which the pressure waves are propagating.

10. A method for detecting pressure waves in multiple media using fiber optic pressure sensors, the method comprising:
arranging at least one fiber optic pressure sensor to detect pressure waves in a first medium;
arranging at least one fiber optic pressure sensor to detect pressure waves in a second medium; and,
using at least one processor to compare the output signals of the fiber optic pressure sensors such that the location of the source of the pressure waves can be determined.

11. The method of claim 10, further comprising using the processor to determine other characteristics of the detected pressure waves and comparing those characteristics to known signatures of noise sources.

12. The system of claim 1, further comprising a first frame, and wherein the at least one fiber optic pressure sensor arranged to detect underwater pressure waves comprises a plurality of fiber optic pressure sensors held in place in the first frame.

13. The system of claim 12, wherein the first frame is configured to hold the plurality of fiber optic sensors arranged to detect underwater pressure waves in a vertical array with a given separation between each fiber optic sensor.

14. The system of claim 1, further comprising a second frame, and wherein the at least one fiber optic pressure sensor arranged to detect atmospheric pressure waves comprises a plurality of fiber optic pressure sensors held in place in the second frame.

15. The system of claim 14, wherein the second frame has a spherical shape and is configured to hold the plurality of fiber optic pressure sensors arranged to detect atmospheric pressure waves with a predetermined radius between each fiber optic pressure sensor.

16. The system of claim 1, wherein the at least one fiber optic sensor arranged to detect underwater pressure waves comprises a plurality of fiber optic pressure sensors, and wherein the at least one fiber optic sensor arranged to detect atmospheric pressure waves comprises a plurality of fiber optic sensors, the system further comprising:
a first frame holding the plurality of fiber optic pressure sensors arranged to detect underwater pressure waves;
a second frame holding the plurality of fiber optic sensors arranged to detect atmospheric pressure waves; and
a float structure connecting the first frame and the second frame.

17. The method of claim 10, wherein arranging at least one fiber optic pressure sensor to detect pressure waves in a first medium comprises arranging a plurality of fiber optic sensors in a first frame; and
wherein arranging at least one fiber optic pressure sensor to detect pressure waves in a second medium comprises arranging a plurality of fiber optic sensors in a second frame.

18. The method of claim 17, further comprising providing a float structure and connecting the first frame and second frame to the float structure.

19. The system of claim 9, wherein the at least one additional fiber optic sensor detects temperature, pressure, or salinity.
